(19) United States
(12) Patent Application Publication
(10) Pub. No.: US 2026/0245277 A1
(43) Pub. Date: Aug. 20, 2026

(54) INFORMATION PROCESSING APPARATUS AND METHOD FOR DISPLAYING DISPLAY OBJECT, IMAGE DISPLAY APPARATUS, AND STORAGE MEDIUM

(71) Applicant: CANON KABUSHIKI KAISHA, Tokyo (JP)

(72) Inventor: SHIMON UEMURA, Tokyo (JP)

(21) Appl. No.: 19/448,908

(22) Filed: Jan. 14, 2026

(30) Foreign Application Priority Data
Feb. 19, 2025 (JP) 2025-025120

(51) Int. Cl. G06T 11/60; G06F 3/01; G06V 40/16; G06V 40/18

(52) U.S. Cl. CPC G06T 11/60; G06F 3/013; G06V 40/174; G06V 40/193

(57) ABSTRACT

A processing apparatus that displays a display object, the processing apparatus includes at least one memory storing program; and one or more processors that when executing the program causes the one or more processors to obtain face portion information regarding a face portion of a user and a level of fatigue of the user using the obtained face portion information, and to determine a display manner for the display object so as to reduce cognitive load as the level of fatigue increases using the obtained level of fatigue.

### BACKGROUND

### Field of the Technology

The aspect of the embodiments relates to an information processing apparatus and a method for displaying a display object, an image display apparatus, and a storage medium.

### Description of the Related Art

In recent years, there have been known video display apparatuses (head-mounted displays (HMD) apparatuses) worn on the head of a user (a viewer) who sees a video image. Virtual reality (VR) content has become widespread along with the HMD apparatuses. In order to meet high demands from users, there are attempts to display VR content in high definition. Along with this, the amount of information displayable to users also increases, and thus, some information may be overlooked by the users.

To address this issue, there has been a technique for changing a display manner based on a user's level of concentration. In Japanese Patent Laid-Open No. 2022-86302, to display an advertisement, a position likely to draw user's attention is set on a screen. Upon determining that the user's gaze is detected at the position, the display manner for an advertisement is changed.

However, in the technique described in Japanese Patent Laid-Open No. 2022-86302, the user's level of fatigue is not taken into consideration. As the user views VR content for a long period of time, with the user's level of fatigue increasing, the user's understanding of the content may decrease, making it difficult to recognize advertisements or the like.

### SUMMARY

According to an aspect of the embodiments, a processing apparatus that displays a display object, the processing apparatus includes at least one memory storing program; and one or more processors that when executing the program causes the one or more processors to obtain face portion information regarding a face portion of a user, and a level of fatigue of the user using the obtained face portion information, and to determine a display manner for the display object so as to reduce cognitive load as the level of fatigue increases using the obtained level of fatigue.

Features of the disclosure will become apparent from the following description of embodiments with reference to the attached drawings. The following description of embodiments is described by way of example.

### BRIEF DESCRIPTION OF THE DRAWINGS

FIG. 1A is a perspective view illustrating a head-mounted display (HMD) apparatus including a headband according to a first embodiment.

FIG. 1B is a perspective view illustrating the HMD apparatus according to the first embodiment.

FIG. 2 is a block diagram illustrating an internal configuration of the HMD apparatus according to the first embodiment.

FIG. 3 is a block diagram illustrating main functions of a central processing unit (CPU) according to the first embodiment.

FIG. 4 is a flowchart illustrating an information processing method according to the first embodiment.

FIG. 5 is a schematic view for describing a principle of a method for detecting a gaze direction.

FIG. 6A is a schematic view of an eyeball image projected on an eyeball image sensor illustrated in FIG. 5.

FIG. 6B is a schematic view of an output intensity of the eyeball image sensor illustrated in FIG. 5.

FIG. 7 is a flowchart illustrating the method for detecting a gaze direction.

FIG. 8 is a flowchart illustrating a method using an opening degree of an eyelid of a user.

FIG. 9A is a schematic view illustrating a distance between upper and lower eyelids.

FIG. 9B is a characteristic diagram illustrating a relationship between the opening degree of the eyelid and a level of fatigue.

FIG. 10 is a flowchart illustrating a method using a range defined by a user's line-of-sight movement per unit time.

FIG. 11A is a schematic view illustrating the range defined by the user's line-of-sight movement based on the level of fatigue.

FIG. 11B is a characteristic diagram illustrating a relationship between the area of the range defined by the user's line-of-sight movement and the level of fatigue.

FIG. 12 is a flowchart illustrating a method using a variance value of the user's gaze point position.

FIG. 13A is a schematic view illustrating variance of the gaze point position based on the level of fatigue.

FIG. 13B is a characteristic diagram illustrating a relationship between the variance value and the level of fatigue.

FIG. 14A is a characteristic diagram illustrating a relationship between the user's level of fatigue and the text usage ratio in a display object.

FIG. 14B is a schematic view illustrating display examples of text and graphics.

FIG. 15 illustrates a notification priority order.

FIG. 16 is a flowchart illustrating an information processing method according to a second embodiment.

FIG. 17 illustrates a relationship between the target character string and the level of comprehension difficulty.

FIG. 18 is a flowchart illustrating an information processing method according to a third embodiment.

### DESCRIPTION OF THE EMBODIMENTS

Some embodiments of the disclosure will now be described in detail with reference to the drawings. The embodiments described in the following are not intended to limit the disclosure according to the claims. A plurality of features is described in the embodiments, but all the features are not necessarily essential and the features may be combined in any manner. Further, like numerals refer to the same or similar configurations in the drawings, and redundant descriptions will be omitted. The details of dimensions and structures indicated in each of the embodiments are not limited. The details of dimensions and structures are not limited to examples described herein and the drawings.

In the embodiments, “face portion information” refers to information regarding the face of a user, “eye portion information” refers to information regarding an eyeball of the user and the surrounding area, both of which are included in the “face portion information”.

### First Embodiment

A first embodiment will now be described. In the embodiment, a head-mounted display (HMD) apparatus including an information processing apparatus will be disclosed.

### <Configuration of HMD Apparatus>

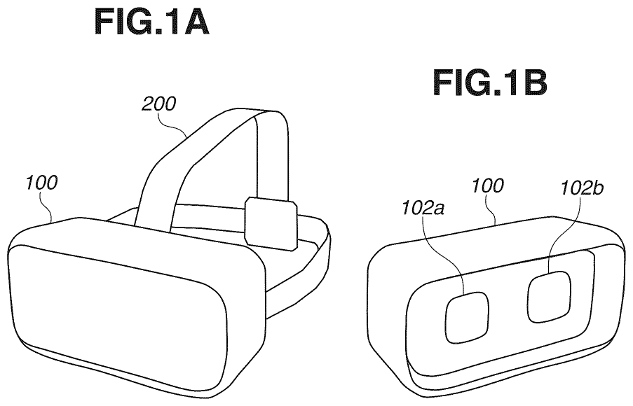

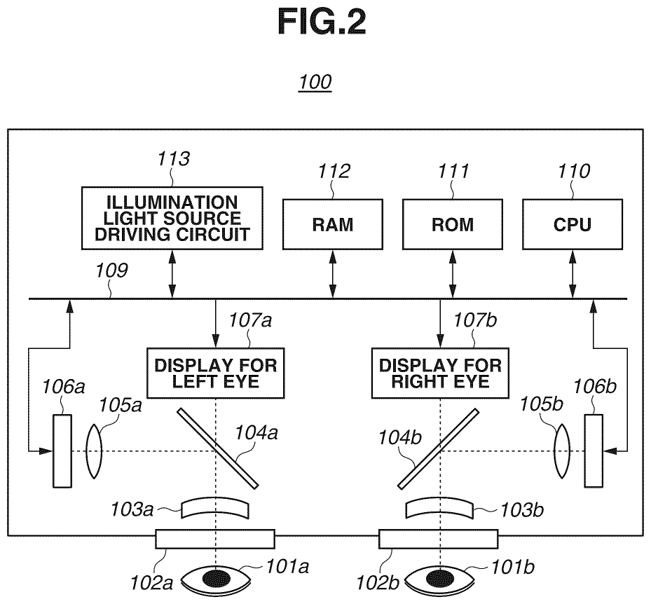

FIG. 1A is a perspective view illustrating an HMD apparatus 100 including a headband 200 according to the embodiment, and FIG. 1B is a perspective view of the HMD apparatus 100 as viewed from a direction different from FIG. 1A. FIG. 2 is a block diagram illustrating an internal configuration of the HMD apparatus 100 according to the embodiment. In the HMD apparatus 100, the information processing apparatus includes a central processing unit (CPU) 110, a read only memory (ROM) 111, a random access memory (RAM) 112, and an illumination light source driving circuit 113.

The HMD apparatus 100 is an image display apparatus worn on the eye portion of the user. As illustrated in FIG. 1A, the user places the HMD apparatus 100 over their eye portion to fix the HMD apparatus to their head portion using the headband 200. As illustrated in FIG. 1B, the HMD apparatus 100 is configured so that the user positions their left eye and right eye in sections of an eyepiece portion 102a for the left eye and an eyepiece portion 102b for the right eye, respectively.

In FIG. 2, a left eyeball 101a and a right eyeball 101b represent the left eye and the right eye of the user, and the user can look into a video image for the left eye and a video image for the right eye through the eyepiece portion 102a for the left eye and the eyepiece portion 102b for the right eye, respectively.

An eyepiece lens 103a for the left eye and an eyepiece lens 103b for the right eye are used to focus a video image viewed by the user.

A beam splitter 104a for the left eye and a beam splitter 104b for the right eye split light of video information about the left eyeball 101a and the right eyeball 101b to a system for line-of-sight detection. The light split by the beam splitter 104a for the left eye and the beam splitter 104b for the right eye is transmitted to an image sensor 106a for the left eyeball and an image sensor 106b for the right eyeball via a light receiving lens 105a for the left eye and a light receiving lens 105b for the right eye, respectively.

Information about video images formed on the image sensor 106a for the left eyeball and the image sensor 106b for the right eye ball is transmitted via a bus 109 to necessary blocks, which will be described below. A display 107a for the left eye and a display 107b for the right eye are display units on which images of a virtual object are displayed. The bus 109 exchanges data between digitally accessible blocks connected to the bus 109.

The CPU 110 is a control unit that generally controls each unit of the HMD apparatus 100 and configures various settings. The CPU 110 is in charge of processing for detecting a gaze point position from eyeball images captured by the image sensor 106a for the left eyeball and the image sensor 106b for the right eyeball, and various types of general calculation processing using values calculated by other units.

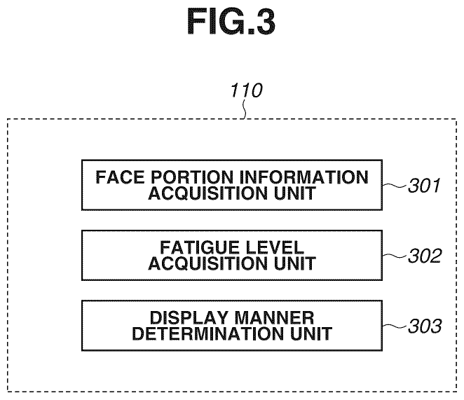

FIG. 3 is a block diagram illustrating main functions of the CPU 110 of the HMD apparatus 100 according to the embodiment.

The CPU 110 includes a face portion information acquisition unit 301, a fatigue level acquisition unit 302, and a display manner determination unit 303.

The face portion information acquisition unit 301 obtains the face portion information regarding the face portion of the user. In the embodiment, the face portion information refers to the eye portion information regarding the user's eyeball and the surrounding region. Here, the “surrounding region of the eyeball” means the surrounding organs of the eyeball (including at least an eyelid). Specifically, the face portion information acquisition unit 301 obtains the eye portion information by, for example, measuring the distance between the upper and lower eyelids using images of the surrounding region of the user's eyeball or measuring the gaze point position using the user's eyeball image.

The fatigue level acquisition unit 302 obtains the level of fatigue of the user using the face portion information obtained by the face portion information acquisition unit 301, in particular, the eye portion information. Specifically, the fatigue level acquisition unit 302 obtains the level of fatigue corresponding to an opening degree using a result of measuring the opening degree of the user's eyelid as the eye portion information. Further, the fatigue level acquisition unit 302 calculates the range defined by line-of-sight movement based on a result of detecting the user's gaze point position per unit time to obtain the level of fatigue based on a size of the line-of-sight movement range defined by line-of-sight movement using the result of measuring the user's gaze point position as the above-described eye portion information. Further, the fatigue level acquisition unit 302 calculates the variance value of user's gaze point positions to obtain the level of fatigue based on the magnitude of the variance value using a result of measuring the user's gaze point positions as the eye portion information.

The display manner determination unit 303 determines a display manner for the display object using the user's level of fatigue obtained by the fatigue level acquisition unit 302 so as to impose reduced cognitive load as the level of fatigue increases. Specifically, the display manner determination unit 303 determines the layout of a display object based on the obtained level of fatigue. When the user's level of fatigue is high, it is conceivable, for example, to determine the layout of the display object by prioritizing an image medium over a text medium as the display object. Further, the display manner determination unit 303 determines the length of text as the display object based on the obtained level of fatigue. Alternatively, the display manner determination unit 303 determines the difficulty level of the content of the display object based on the obtained level of fatigue. When the user's level of fatigue is high, it is conceivable, for example, to simplify the content of text as the display object. When the user's level of fatigue is high, an image as the display object may be converted into an easily viewable image. When the user's level of fatigue is high, the display manner determination unit 303 modifies or summarizes text as the display object to shorten the text. When the user's level of fatigue is high, the display manner determination unit 303 converts text as the display object into an image.

The embodiment will be described on the assumption that processing described below is performed by software using the CPU 110, but part of or all the processing described below may be performed by hardware. A dedicated circuit (an Application Specific Integrated Circuit (ASIC)), a processor (a reconfigurable processor or a digital signal processor (DSP)), or the like can be used as the hardware. Further, the HMD apparatus 100 may include a communication unit for communicating with an external device, acquire input data, control programs, datasets for learning, and the like from the external device via the commutation unit, and output processing results and the like to the external device via the communication unit.

The ROM 111 stores control programs for processing performed by the CPU 110, and information required for the processing.

The RAM 112 stores as digital data video images captured by the image sensor 106a for the left eyeball and the image sensor 106b for the right eyeball. Further, the RAM 112 is used as a temporary data storage required for the processing performed by the CPU 110.

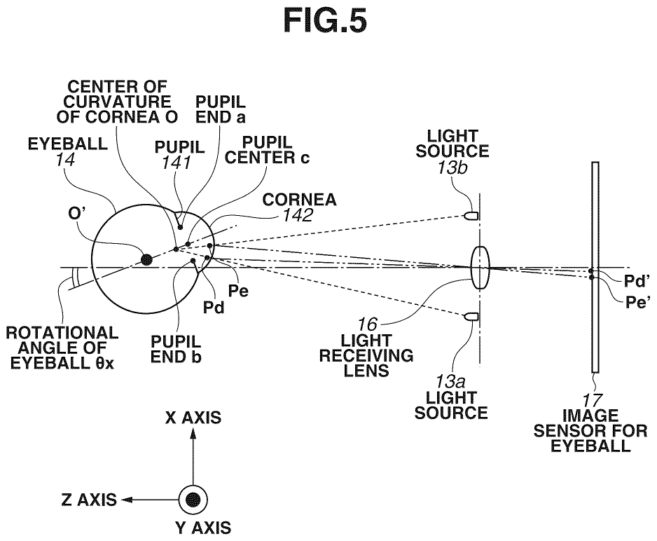

The illumination light source driving circuit 113 controls lighting of and the quantity of light from light sources 13a and 13b, both of which illuminate an eyeball 14 described below in FIG. 5.

### <Information Processing Method>

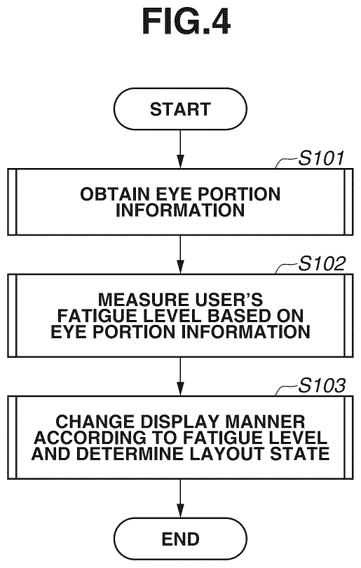

FIG. 4 is a flowchart illustrating an information processing method according to the embodiment.

The processing illustrated in the flowchart of FIG. 4 starts in response to a command to display a virtual object being issued at the time of video display processing of the HID apparatus 100.

When the processing illustrated in FIG. 4 starts, first, in step S101, the face portion information acquisition unit 301 of the CPU 110 obtains eye portion information regarding the user's eyeball and the surrounding region of the user's eyeball as the face portion information about the user. Examples of the eye portion information include predetermined information regarding images of the user's eyeball and the surrounding region of the user's eyeball captured by a camera, which is a non-illustrated unit for detecting the surrounding region of the user's eyeball, and information about coordinates of a gaze point position calculated using the eyeball image. The obtained eye portion information is stored in the ROM 111.

In step S102, the fatigue level acquisition unit 302 of the CPU 110 obtains the level of fatigue of the user using the eye portion information obtained in step S101.

In step S103, the display manner determination unit 303 of the CPU 110 determines the display manner (a display manner that imposes reduced cognitive load as the level of fatigue increases) for the display object, such as a virtual object, using the level of fatigue obtained in step S102. The CPU 110 projects the display object in the display manner determined by the display manner determination unit 303 on the display 107a for the left eyeball and the display 107b for the right eyeball.

### [Obtaining Viewpoint Position Coordinates]

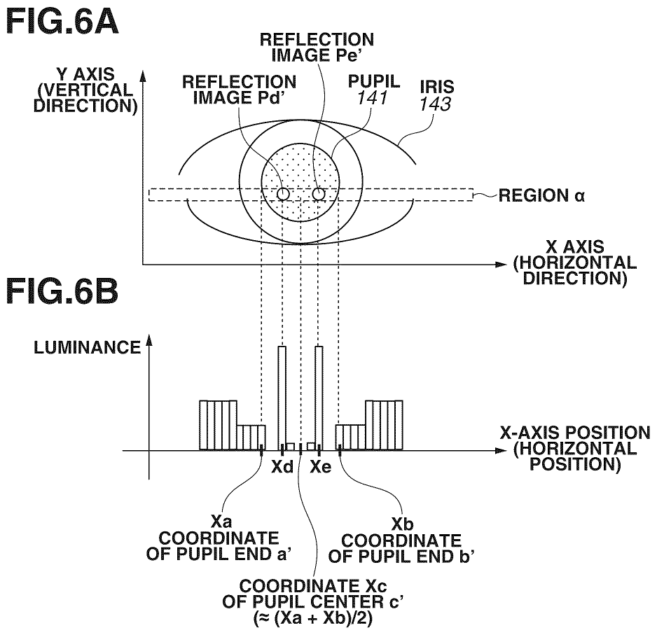

A method will be described of detecting a gaze direction for obtaining the gaze point position coordinates in step S101 in FIG. 4. FIG. 5 is a schematic view for describing the principle of the method of detecting a gaze direction, and corresponds to a summary view of an optical system for detecting the user's gaze direction in the above-described configuration illustrated in FIG. 2. FIGS. 6A and 6B are schematic views regarding the eyeball image projected on an eyeball image sensor 17 illustrated in FIG. 5. FIGS. 6A and 6B illustrate the eyeball image and the output intensity of the eyeball image sensor 17, respectively. Such an eyeball image sensor is installed in the HID apparatus 100 both on the left and the right.

In FIG. 5, the illumination light sources 13 are light sources, such as light emitting diodes that emit infrared light imperceptible to the user, and each light source illuminates the eyeball 14 of the user. Some of the illumination light reflected on the eyeball 14 is concentrated onto the eyeball image sensor 17 by a light receiving lens 16. In this case, the HMD apparatus 100 includes the two eyeball image sensors as illustrated in FIG. 2, which capture images of the left and right eyeballs, respectively.

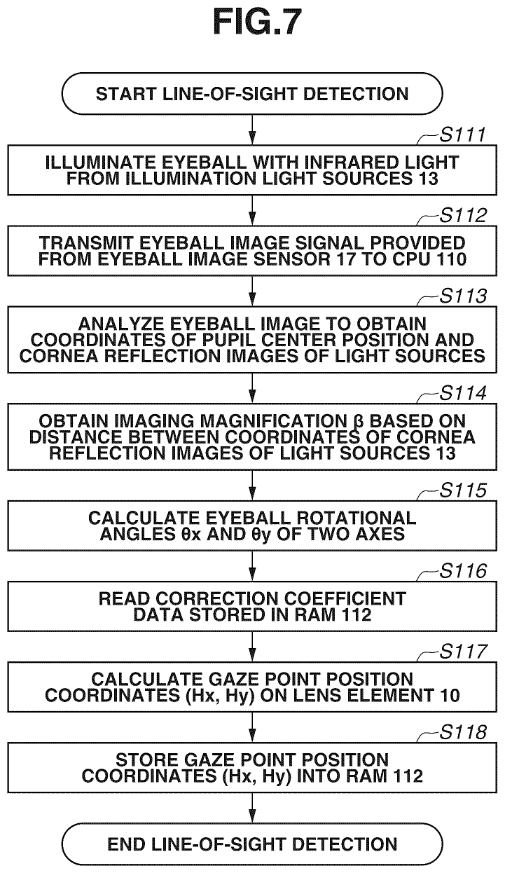

FIG. 7 is a flowchart illustrating the method for detecting a gaze direction.

In FIG. 7, when the gaze direction detection is started, in step S111, the light sources 13a and 13b each emit infrared light toward the eyeball 14 of the viewer. An image of the user's eyeball 14 illuminated with the infrared light is formed on the eyeball image sensor 17 via the light receiving lens 16, and is photoelectrically converted by the eyeball image sensor 17 to make the eyeball image processable as an electric signal.

In step S112, the eyeball image signal provided from the eyeball image sensor 17 as described above is transmitted to the face portion information acquisition unit 301 of the CPU 110.

In step S113, the face portion information acquisition unit 301 determines coordinates of points corresponding to cornea reflection images Pd and Pe of the light sources 13a and 13b and a pupil center c illustrated in FIG. 5 based on information about the eyeball image signal acquired in step S112. The infrared light emitted from the light sources 13a and 13b illuminates a cornea 142 of the eyeball 14 of the viewer. In this case, the cornea reflection images Pd and Pe formed by some of the infrared light reflected from the surface of the cornea 142 are collected by the light receiving lens 16 to be imaged on the eyeball image sensor 17 (illustrated points Pd′ and Pe′). Similarly, light fluxes from end portions a and b of a pupil 141 are also imaged on the eyeball image sensor 17. With a horizontal direction set as an X axis and a vertical direction set as a Y axis as illustrated in FIGS. 6A and 6B, Xd and Xe represent coordinates of the cornea reflection images Pd′ and Pe′ of the light sources 13a and 13b in the X-axis direction (the horizontal direction), respectively. Further, Xa and Xb represent coordinates of images a′ and b′, both of which are formed by the light fluxes from the end portions a and b of the pupil 141 in the X-axis direction, respectively.

In FIG. 6B, extremely high levels of luminance are obtained at the positions Xd and Xe corresponding to the cornea reflection images Pd′ and Pe′ of the light sources 13a and 13b. Extremely low levels of luminance are obtained in the region between the coordinates Xa and Xb corresponding to the region of the pupil 141 except for the positions Xd and Xe. On the other hand, values approximately in the middle between the above-described two types of luminance levels are obtained in a region having X coordinate values lower than Xa and a region having X coordinate values higher than Xb, which correspond to a region of an iris 143 outside the pupil 141.

The X coordinates Xd and Xe of the cornea reflection images Pd′ and Pe′ of the light sources 13a and 13b and the X coordinates Xa and Xb of the images a′ and b′ of the pupil ends can be obtained based on information about fluctuation in the luminance level with respect to the above-described X coordinate positions. Further, when a rotational angle θx of the optical axis of the eyeball 14 with respect to the optical axis of the light receiving lens 16 is small, a coordinate Xc of a portion (assumed to be represented by c′) corresponding to the pupil center c imaged on the eyeball image sensor 17 can be expressed as Xc≈(Xa+Xb)/2. In light of the above, the X coordinate of c′ corresponding to the pupil center c imaged on the eyeball image sensor 17 and the coordinates of the cornea reflection images Pd′ and Pe′ of the light sources 13a and 13b can be estimated.

In step S114, the face portion information acquisition unit 301 calculates an imaging magnification R of the eyeball image. The imaging magnification R is determined based on the position of the eyeball 14 with respect to the light receiving lens 16, and can be practically found as a function of the distance (Xd-Xe) between the cornea reflection images Pd′ and Pe′.

In step S115, the face portion information acquisition unit 301 calculates the rotational angles θx and θy. The X coordinate of the midpoint between the cornea reflection images Pd and Pe and the X coordinate of the center of curvature O of the cornea 142 substantially match each other. Assuming that Oc represents a standard distance between the center of curvature O of the cornea 142 and the center c of the pupil 141, the rotational angle θx of the optical axis of the eyeball 14 in a Z-X plane can be calculated using the following relational expression.

$$θ x = β * Oc * SIN θ x \approx \{ ( Xd + Xe ) / 2 \} - Xc$$

Further, FIGS. 5, 6A, and 6B illustrate the example of calculating the rotational angle θx when the eyeball 14 of the viewer rotates in a plane perpendicular to the Y axis, but the rotational angle θy when the eyeball 14 of the viewer rotates in a plane perpendicular to the X axis is also calculated in the same manner.

After the rotational angles θx and θy of the optical axis of the eyeball 14 of the viewer are calculated in step S115, in step S116, the face portion information acquisition unit 301 determines a position in the user's gaze direction (a position of the point being gazed by the user, also referred to as the gaze point) on a display 107 using the rotational angles θx and θy. Let (Hx, Hy) denote the coordinates corresponding to the center c of the pupil 141 on the display 107, and the gaze point position can be calculated using the following expressions.

$$Hx = m \times ( Ax \times θ x + Bx )$$

$$Hy = m \times ( Ay \times θ y + By )$$

In this case, a coefficient m is a constant that represents the relationship between an angle of the user's eyeball 14 and a position of the user's eyeball 14 on the display 107, serves as a conversion coefficient for converting the rotational angles θx and θy into position coordinates corresponding to the center c of the pupil 141 on the display 107, and is assumed to be predetermined and stored in the RAM 112. Further, Ax, Bx, Ay, and By are gaze direction correction coefficients for compensating individual differences in the user's gaze direction, which are assumed to be obtained by performing a calibration operation described below and stored in the RAM 112 before the start of the gaze direction detection.

In step S117, the face portion information acquisition unit 301 calculates the gaze point position coordinates (Hx, Hy) of the center c of the pupil 141 on the display 107 as the eye portion information as described above.

In step S118, the gaze point position coordinates (Hx, Hy) are stored in the RAM 112.

The method of obtaining the gaze point coordinates on the display 107 using the cornea reflection images Pd′ and Pe′ of the light sources 13a and 13b has been described, but the method is not limited thereto. Any method is applicable to the embodiment as long as the method can obtain an eyeball rotational angle based on a captured eyeball image.

### [Obtaining User's Level of Fatigue]

The method will now be described for obtaining the user's level of fatigue in step S102 illustrated in FIG. 4.

Examples of the method for obtaining the level of fatigue include a method using an opening degree of the user's eyelid, a method using a range defined by the user's line-of-sight movement per unit time, and a method using a variance value of the line of sight in the range defined by the user's line-of-sight movement. The level of fatigue is detected using one of these methods or by combining two or more of these methods. These methods will now be described one by one.

### (Method Using Opening Degree of User's Eyelid)

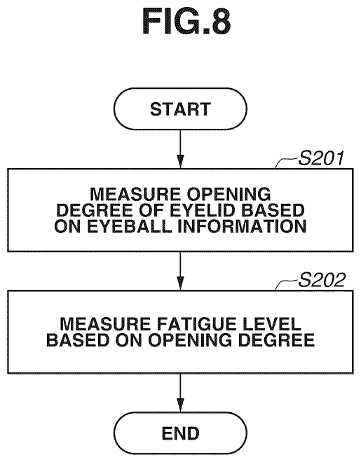

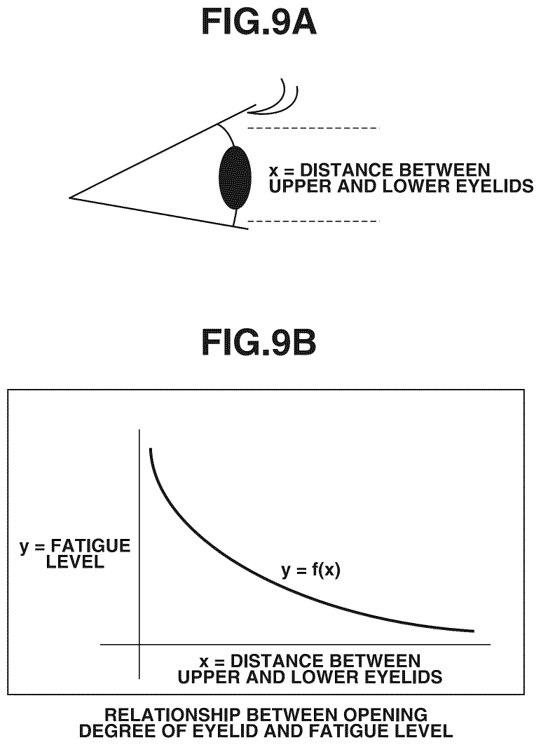

FIG. 8 is a flowchart illustrating the method using the opening degree of the user's eyelid. For convenience of the description, step S201 in FIG. 8 constitutes a detailed implementation of step S101 in FIG. 4. FIGS. 9A and 9B are diagrams for describing the method using the opening degree of the user's eyelid. FIG. 9A is a schematic view illustrating a distance between the upper and lower eyelids, and FIG. 9B is a characteristic diagram illustrating a relationship between the opening degree of the user's eyelid and the level of fatigue.

When the processing illustrated in FIG. 8 starts, first, in step S201, the face portion information acquisition unit 301 measures, as illustrating in FIG. 9A, an opening degree of the user's eyelid as a distance between the upper and lower eyelids using an image of the surrounding region of the eyeball of the user to obtain the degree as the eye portion information. The face portion information acquisition unit 301, which measures the distance between the upper and lower eyelids, can employ any known method. For example, semantic segmentation may be used to identify the surrounding region of the eyeball including the user's eyelid, and then obtains the distance between the upper and lower eyelids.

In step S202, the fatigue level acquisition unit 302 obtains the level of fatigue of the user using the distance between the upper and lower eyelids obtained in step S201. It has been found that the distance between the user's upper and lower eyelids and a user's level of fatigue have a correlative relationship as illustrated in FIG. 9B. The level of fatigue of the user corresponding to the distance between the upper and lower eyelids is obtained based on the correlative relationship. In this manner, the level of fatigue is determined to be lower as the distance between the upper and lower eyelids increases and higher as the distance decreases.

(Method using Range defined by User's Line-of-Sight Movement per Unit Time).

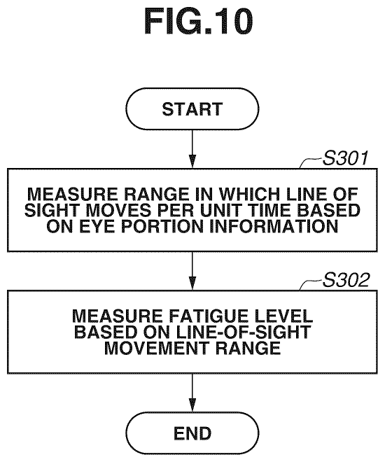

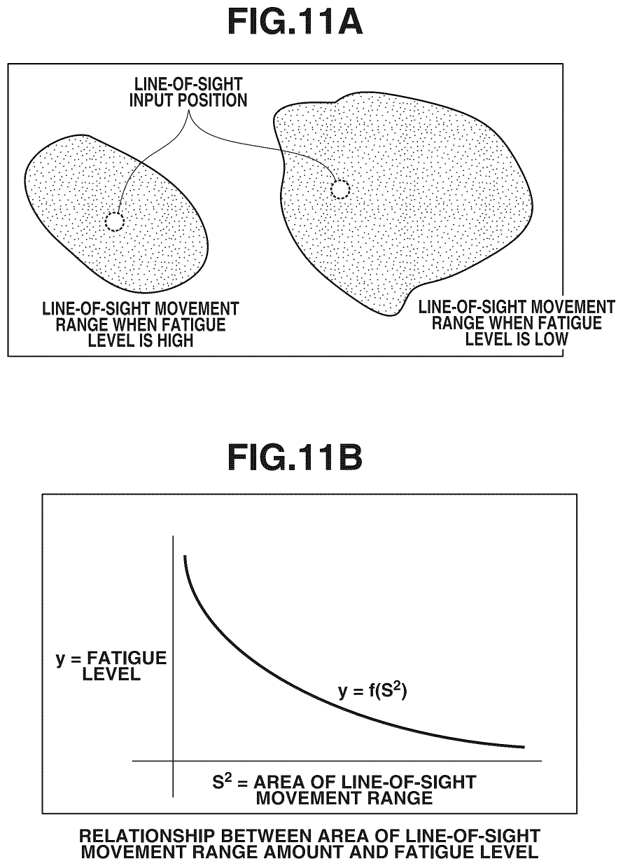

FIG. 10 is a flowchart illustrating the method using a range defined by the user's line-of-sight movement per unit time. FIGS. 11A and 11B illustrate the method using the range defined by user's line-of-sight movement per unit time. FIG. 11A is a schematic view illustrating a range defined by the line-of-sight movement based on the level of fatigue, and FIG. 11B is a characteristic diagram illustrating a relationship between the area of the range defined by the line-of-sight movement and the level of fatigue.

When the processing illustrated in FIG. 10 starts, first, in step S301, the fatigue level acquisition unit 302 measures, as illustrates in FIG. 11A, a range defined by user's line-of-sight movement per unit time using the gaze point position coordinates obtained by the method for detecting a gaze direction illustrated in FIG. 5 as the eye portion information.

In step S302, the fatigue level acquisition unit 302 obtains the user's level of fatigue using the area of the range defined by the line-of-sight movement per unit time obtained in step S301. It has been found that the area of the range defined by user's line-of-sight movement per unit time and the user's level of fatigue have a correlative relationship as illustrated in FIG. 11B. The level of fatigue of the user corresponding to the area of the range defined by the line-of-sight movement is obtained based on the correlative relationship. In this manner, the level of fatigue is determined to be lower as the area of the range defined by the line-of-sight movement increases and higher as the area of the range defined by the line-of-sight movement decreases.

(Method using Variance Value of Gaze Point Position in Range defined by User's Line-of-Sight Movement).

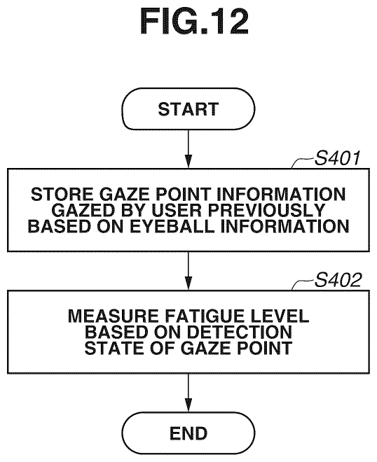

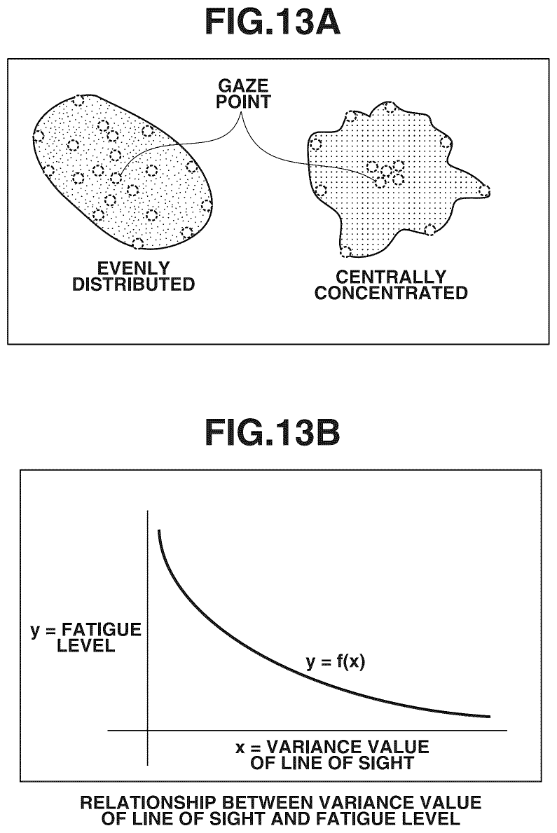

FIG. 12 is a flowchart illustrating the method using a variance value of the user's gaze point position. FIGS. 13A and 13B illustrate the method using the variance value of the user's gaze point position. FIG. 13A is a schematic view illustrating variance of the gaze point position based on the level of fatigue, and FIG. 13B is a characteristic diagram illustrating a relationship between the variance value and the level of fatigue. In this case, it is on the assumption that the variance of the gaze point position is the sum of variances in the X direction and the Y direction.

When the processing illustrated in FIG. 12 starts, first, in step S401, the fatigue level acquisition unit 302 reads, as illustrates in FIG. 13A, previous user's gaze point positions using the gaze point position coordinates obtained by the method for detecting a gaze direction illustrated in FIG. 5 as the eye portion information. The fatigue level acquisition unit 302 calculates a variance value of the gaze point position using the previous gaze point positions.

In step S402, the fatigue level acquisition unit 302 obtains the user's level of fatigue using the variance value of the user's gaze point position obtained in step S401. It has been found that the variance value of the user's gaze point position and the user's level of fatigue have a correlative relationship as illustrated in FIG. 13B. The level of fatigue of the user corresponding to the variance value of the gaze point position is obtained based on the correlative relationship. In this manner, the level of fatigue is determined to be lower as the variance value of the gaze point position increases and higher as the variance value decreases.

### [Determine Display Manner of Display Object]

The method will now be described of determining the display manner for the display object in step S103 illustrated in FIG. 4. In the embodiment, an example will be described where the layout of text, graphic, and other forms as the display manner for the display object is determined as appropriate based on the level of fatigue.

Examples of the method of determining the display manner for the display object include a technique that prioritizes an image medium over a text medium to place the image medium in a more visible position, and a technique that displays a short warning message instead of a long warning message. The display manner for the display object is determined using one of these methods or by combining both of the methods.

(Method that Prioritizes Image Medium over Text Medium to Place Image Medium in more Visible Position)

For a user in a state of high fatigue, it is easier to obtain information from an image medium, such as an image or a photograph, than from a text medium, such as a written message. Reasons therefor will now be described.

When the user's level of fatigue is high, the user can perceive characters at the moment the user sees the written message, but information processing is required to comprehend the message. Next, to read the written message, in one embodiment, it is necessary to move their gaze, but less eye movement can result in less fatigue. Thus, an image or a photograph that presents information in a unified manner causes less fatigue in the user than a written message. Further, an image or a photograph is easier to understand intuitively than a written message, allowing reduction of cognitive load.

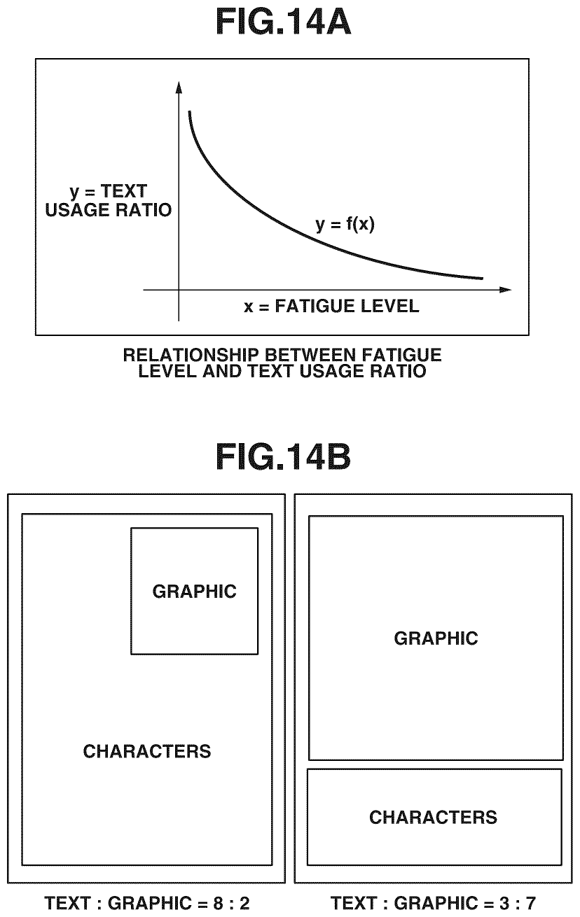

FIGS. 14A and 14B are diagrams for describing a display manner for a written message and an image. FIG. 14A is a characteristic diagram illustrating a relationship between the user's level of fatigue and the text usage ratio in a display object, and FIG. 14B is a schematic view illustrating display examples of text and graphic.

It has been found that the user's level of fatigue and the text usage ratio in the display object have a correlative relationship as illustrated in FIG. 14A. The fatigue level acquisition unit 302 determines and changes the display manner of the display object using the correlative relationship.

The display manner determination unit 303 determines and changes the display manner so that the proportion of the text relative to the graphic in the displayed object becomes higher (for example, the text: the graphic=8:2) as illustrated in FIG. 14B when the user's level of fatigue obtained in step S102 in FIG. 4 is low. On the other hand, the display manner determination unit 303 determines and changes the display manner so that the proportion of the text relative to the graphic in the displayed object becomes lower (for example, the text: the graphic=3:7) when the user's level of fatigue obtained in step S102 in FIG. 4 is high.

As the user's level of fatigue increases, in one embodiment, the proportion of the text used is decreased and the proportion of the image (the image medium) is increased, such as a photograph or a graphic in the display. For example, in a case where the display object is an advertisement intended to efficiently convey information to the user, an advertisement medium including a large amount of text, which can deliver a large amount of information, is used when the user's level of fatigue is low. Conversely, when the user's level of fatigue is high, an advertisement that uses more photographs or graphics, which are easier to understand than text, is displayed. In this manner, a high advertisement effect can be exhibited by determining and changing the display manner for the display object based on the level of fatigue.

(Method of Displaying Short Warning Message instead of Long Warning Message)

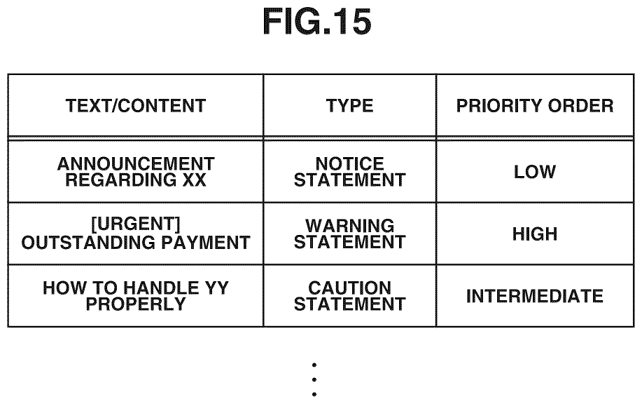

With the user's high level of fatigue, in one embodiment, the display is switched to a short warning message to avoid the user's reading long text, such as a long warning message. Further, as illustrated in FIG. 15, a priority order is set for warning messages based on items, such as importance and urgency, and then determine information to display based on the level of fatigue.

The display manner determination unit 303, for example, displays all warning messages with low, intermediate, and high priorities when the user's level of fatigue obtained in step S102 in FIG. 4 is low. On the other hand, the display manner determination unit 303 displays only a warning message with high priority when the user's level of fatigue obtained in step S102 in FIG. 4 is high. Important information can be conveyed to the user without excess or deficiency by determining and changing the display manner of a warning message as the display object based on the level of fatigue in this manner.

The embodiment is not limited to the above-described methods. Any method that imposes reduced cognitive load of the display object by changing the display manner for the display object (text and an image (a photograph, a graphic, or the like)) based on the level of fatigue is included in the embodiment.

As described above, according to the embodiment, a highly convenient information processing apparatus that changes the display manner based on the user's level of fatigue to facilitate the recognition of a display object, and the HMD apparatus 100 including the information processing apparatus can be implemented.

### Second Embodiment

A second embodiment will now be described.

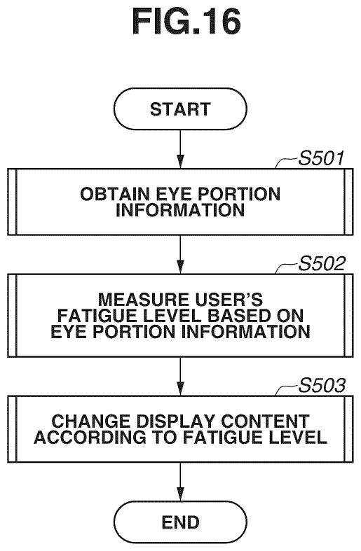

FIG. 16 is a flowchart illustrating an information processing method according to the embodiment.

In the embodiment, steps S501 and S502 are similar to steps S101 and S102 illustrated in FIG. 4 according to the first embodiment, and thus, detailed descriptions of these steps will be omitted. In the embodiment, an example will be described where a display manner for a display object is determined as appropriate based on the user's level of fatigue in the method for determining the display manner for the display object in step S503.

In the embodiment, an example will be described of determining a display object based on a difficulty level of the content of the display object as the method of determining the display manner for the display object. Specific examples thereof include a method of simplifying the content of the text as the display object, and a method of converting the display object into an easily viewable image when the user's level of fatigue is high. The display manner of the display object is determined using one of these methods or by combining both of the methods.

### (Method of Simplifying Content of Text as Display Object)

A display object, such as text, may be simplified using, for example, a proverb or a slang.

Proverbs are concise and easy to understand. However, the level of familiarity varies depending on generational and cultural differences, and it may take longer to understand depending on the level of fatigue.

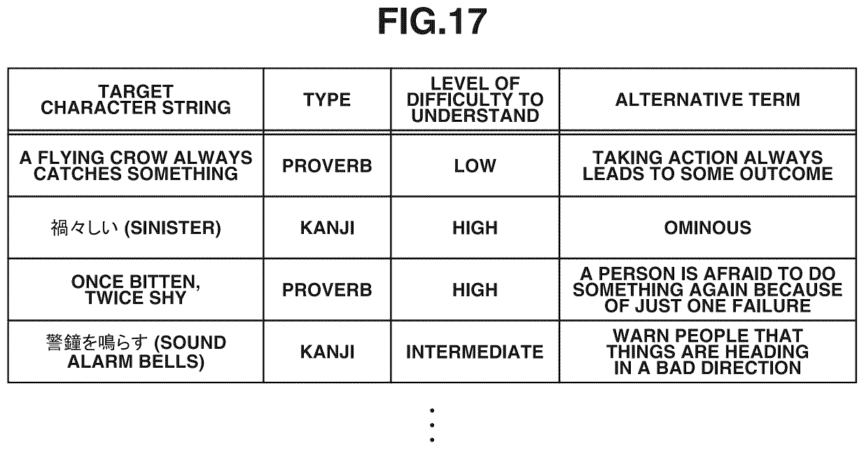

As illustrated in FIG. 17, for a target character string, the level of comprehension difficulty is set based on, for example, the frequency of daily use or the length of the character string, and the display is switched to an alternative term based on the level of fatigue. When the level of fatigue is high, text with the meaning corresponding to a proverb is prepared, and a determination is made whether to change the display content based on the level of fatigue. Similarly, for kanji characters, the degree of recognition and difficulty is set, and the kanji characters are converted into other kanji characters or an expression when the user's level of fatigue is high.

In step S503, the display manner determination unit 303, for example, switches the display manner to a presentation mainly using text with a high level of comprehension difficulty when the user's level of fatigue obtained in step S102 in FIG. 4 is low. On the other hand, the display manner determination unit 303 may switch the display manner to only text with a low level of comprehension difficulty (with an intermediate level of comprehension difficulty as appropriate) when the user's level of fatigue obtained in step S102 in FIG. 4 is high. In this manner, the display manner determination unit 303 may change the color of text that includes a term intended to attract attention so as to guide the user's gaze when the level of fatigue is high. Information necessary for the user can be conveyed with lower cognitive load by determining and changing the display manner for the text as the display object based on the level of fatigue.

(Method of Converting Image as Display Object into Easily Viewable Image)

When an image displayed to the user includes, for example, an object having the same color as the background of the object of interest, making it difficult to distinguish the background from the object of interest, or a plurality of objects of interest, the user's cognitive load may increase.

In step S503, when the user's level of fatigue obtained in step S102 in FIG. 4 is high, the display manner determination unit 303 determines and changes the display manner for the display object as follows. For example, the display manner determination unit 303 converts the display object into a monochrome image or a linear image, adjusts clarity or perform trimming to make the display object easier to view, or uses an accent color to highlight the display object. Further, if it is difficult to distinguish a large number of objects, the objects are converted into illustrations to make the objects easier to view. In this manner, the user's cognitive load can be reduced and the visibility of the display object can be increased by determining and changing the display manner for the display object based on the level of fatigue.

The embodiment is not limited to the above-described methods. Any method that reduces cognitive load of the display object by changing the display manner for the display object (text and an image (a photograph, a graphic, or the like)) based on the level of fatigue is included in the embodiment.

As described above, according to the embodiment, a highly convenient information processing apparatus that changes the display manner based on the user's level of fatigue to facilitate the recognition of a display object, and the HMD apparatus 100 including the information processing apparatus can be implemented.

### Third Embodiment

A third embodiment will now be described.

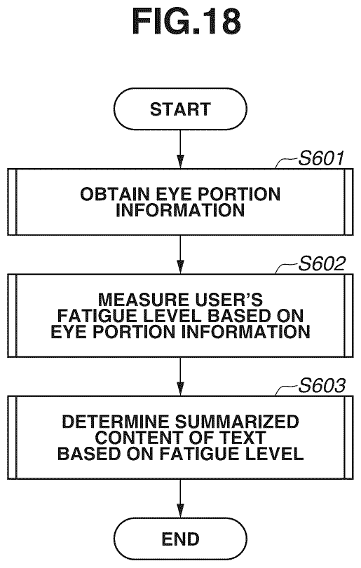

FIG. 18 is a flowchart illustrating an information processing method according to the embodiment.

In the embodiment, steps S601 and S602 are similar to steps S101 and S102 illustrated in FIG. 4 according to the first embodiment, and thus, detailed descriptions of these steps will be omitted. In the embodiment, an example will be described of determining, as appropriate based on a level of fatigue, display content as the display manner for a display object in a method of determining the display manner for the display object in step S603.

Examples of the method of determining the display manner for the display object include a method of modifying or summarizing text based on a level of fatigue and a method of converting text into an image based on the level of fatigue. The display manner for the display object is determined using one of these methods or by combining both of the methods.

### (Method of Modifying or Summarizing Text Based on Level of Fatigue)

In step S603, the display manner determination unit 303, for example, modifies or summarizes text to be shortened when the user's level of fatigue obtained in step S102 in FIG. 4 is high.

As for the display manner determination unit 303, any known method can be employed. For example, it is conceivable to employ machine learning to perform syntactic analysis or extraction of text, and then generate a shorter text to display the shorter text. The embodiment is not limited to the above-described methods. Any method that performs text modification or summarization as appropriate is included in the embodiment. In this manner, information necessary for the user can be conveyed with lower cognitive load by determining and changing the display manner for the text as the display object based on the level of fatigue.

(Method of Converting Text into Image based on Level of Fatigue)

With the user in a highly fatigued state, text imposes a high cognitive load compared with an image (a photograph, a graphic, or the like), and thus, in one embodiment, a display manner without text is desirable.

In step S603, the display manner determination unit 303, for example, displays an image instead of text in the display object when the user's level of fatigue obtained in step S102 in FIG. 4 is high. As for the display manner determination unit 303, any known method can be employed. For example, it is conceivable to employ machine learning to perform syntactic analysis or extraction of text, and then generate an image corresponding to the text content to display the image. The embodiment is not limited to the above-described method. Any method that generates an image from text as appropriate is included in the embodiment. In this manner, information necessary for the user can be conveyed with lower cognitive load by determining and changing the display manner for the display object based on the level of fatigue.

Further, the embodiment is not limited to the above-described method. Any method that reduces the cognitive load of a display object by changing the display manner from text to an image based on the level of fatigue.

As described above, according to the embodiment, a highly convenient information processing apparatus that changes the display manner based on the user's level of fatigue to facilitate the recognition of the display object, and the HMD apparatus 100 including the information processing apparatus can be implemented.

The example is described of using the eye portion information regarding the user's eyeball and the surrounding region of the user's eyeball as the face portion information about the user in the first and second embodiments. However, the face portion information about the user is not limited thereto. For example, it is conceivable to use information, such as the user's facial expression and complexion, as the face portion information. For example, the facial expression on the face portion has been found to exhibit characteristic change due to fatigue. Specifically, it has been confirmed that (1) the facial expression at the left and right eye portions changes symmetrically, (2) the frontalis muscle and the corrugator muscle in the face portion significantly change, (3) the depressor anguli oris muscle significantly changes, and the like.

For example, these facial expressions on the user's face portion are captured by a non-illustrated camera provided in the HMD apparatus 100 to obtain a facial expression image. The face portion information acquisition unit 301 obtains the face portion information regarding, for example, the above-described (1) to (3) using this facial expression image.

The fatigue level acquisition unit 302 obtains the level of fatigue of the user using the face portion information. For example, a trained model obtained through machine learning is used for the fatigue level acquisition unit 302. In this case, information regarding a predetermined portion in the face portion, such as the region of the depressor anguli oris muscle, from a facial expression image captured by the above-described camera is used as the face portion information. Specifically, for example, a trained model is used that is generated through learning by associating a plurality of pieces of face portion information as input data with levels of fatigue corresponding to, for example, states of the depressor anguli oris muscle in facial expression images as training data (ground truth). The level of fatigue estimated as the region information about the portion of the depressor anguli oris muscle can be obtained as output data by inputting the face portion information to the trained model as the input data.

The display manner determination unit 303 then determines and changes the display manner of the display object as appropriate so as to reduce cognitive load as the level of fatigue increases using the user's level of fatigue obtained by the fatigue level acquisition unit 302.

In this manner, even when the information regarding, for example, the facial expression on the user's face portion instead of the eye portion information is used, an information processing apparatus that provides high convenience by changing the display manner based on the user's level of fatigue to facilitate the recognition of the display object, and the HMD apparatus 100 including the information processing apparatus can be implemented.

In the above-described embodiments, a computer program for controlling the HMD apparatus 100 is stored in a storage medium, such as the ROM 111. This computer program is a control program for carrying out various functions of the CPU 110 of the HMD apparatus 100. Specifically, this control program corresponds to each step illustrated in FIGS. 4, 7, 8, 10, 12, 16, and 18. In FIG. 4, steps S101 to S103 correspond thereto. In FIG. 7, steps S111 to S118 correspond thereto. In FIG. 8, steps S201 and S202 correspond thereto. In FIG. 10, steps S301 and S302 correspond thereto. In FIG. 12, steps S401 and S402 correspond thereto. In FIG. 16, steps S501 to S503 correspond thereto. In FIG. 18, steps S601 to S603 correspond thereto. The CPU 110 as a computer then reads and executes the computer program from the storage medium, such as the ROM 111. The embodiments can also be implemented by supplying this computer program to a system or an apparatus via a network or a storage medium, and causing one or more processors in a computer of the system or the apparatus to read and execute the program. Further, the embodiments can also be implemented with a circuit (for example, an ASIC) that carries out one or more functions. The program code itself read from the recording medium carries out the functions of the above-described embodiments, and the storage medium on which the program code is recorded is included in the disclosure.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2025-025120, filed Feb. 19, 2025, which is hereby incorporated by reference herein in its entirety.

What is claimed is:

1. An processing apparatus that displays a display object, the processing apparatus comprising:
at least one memory storing program; and
one or more processors that when executing the program causes the one or more processors to:
obtain face portion information regarding a face portion of a user;
obtain a level of fatigue of the user using the obtained face portion information; and
determine a display manner for the display object so as to reduce cognitive load as the level of fatigue increases using the obtained level of fatigue.

2. The processing apparatus according to claim 1, wherein the face portion information is eye portion information regarding an eyeball of the user and a surrounding region of the eyeball of the user.

3. The processing apparatus according to claim 2, wherein the one or more processors further use a result of measuring an opening degree of an eyelid of the user as the eye portion information to obtain the level of fatigue corresponding to the opening degree.

4. The processing apparatus according to claim 2, wherein the one or more processors further use a gaze point position of the user as the eye portion information to calculate a range defined by line-of-sight movement based on a result of detecting the gaze point position of the user per unit time, and then obtain the level of fatigue based on a size of the range defined by the line-of-sight movement.

5. The processing apparatus according to claim 2, wherein the one or more processors further use a gaze point position of the user as the eye portion information to calculate a variance value of the gaze point position of the user, and then obtain the level of fatigue based on magnitude of the variance value.

6. The processing apparatus according to claim 1, wherein the one or more processors further determine a layout of the display object based on the level of fatigue.

7. The processing apparatus according to claim 6, wherein the one or more processors further prioritize an image medium over a text medium as the display object to determine the layout in a case where the level of fatigue is high.

8. The processing apparatus according to claim 1, wherein the one or more processors further determine a length of text as the display object based on the level of fatigue.

9. The processing apparatus according to claim 1, wherein the one or more processors further determine a difficulty level of content of the display object based on the level of fatigue.

10. The processing apparatus according to claim 9, wherein the one or more processors further simplify the content of the text as the display object in a case where the level of fatigue is high.

11. The processing apparatus according to claim 9, wherein the one or more processors further convert an image as the display object into an easily viewable image in a case where the level of fatigue is high.

12. The processing apparatus according to claim 1, wherein the one or more processors further modify or summarize text as the display object so that the text is shortened in a case where the level of fatigue is high.

13. The processing apparatus according to claim 1, wherein the one or more processors further convert text as the display object into an image in a case where the level of fatigue is high.

14. A display apparatus configured to be worn on an eye portion of a user, the display apparatus comprising:
the processing apparatus according to claim 1; and
a display configured to display the display object in the display manner determined by the processing apparatus.

15. A processing method that displays a display object, the processing method comprising:
obtaining face portion information regarding a face portion of a user;
obtaining a level of fatigue of the user using the face portion information; and
determining a display manner for the display object so as to reduce cognitive load as the level of fatigue increases using the level of fatigue.

16. The processing method according to claim 15, further comprising determining one of a layout of the display object based on the level of fatigue, a length of text as the display object based on the level of fatigue, and a difficulty level of content of the display object based on the level of fatigue.

17. The processing method according to claim 15, further comprising modifying or summarizing text as the display object so that the text is shortened in a case where the level of fatigue is high.

18. A non-transitory computer-readable storage medium storing a program that causes a computer to perform a processing method for displaying a display object, the processing method comprising:
obtaining face portion information regarding a face portion of a user;
obtaining a level of fatigue of the user using the face portion information; and
determining a display manner for the display object so as to reduce cognitive load as the level of fatigue increases using the level of fatigue.

19. The non-transitory computer-readable storage medium according to claim 18, further comprising determining one of a layout of the display object based on the level of fatigue, a length of text as the display object based on the level of fatigue, and a difficulty level of content of the display object based on the level of fatigue.

20. The non-transitory computer-readable storage medium according to claim 18, further comprising modifying or summarizing text as the display object so that the text is shortened in a case where the level of fatigue is high.
